(19) United States
(12) Patent Application Publication
(10) Pub. No.: US 2018/0082194 A1
(43) Pub. Date: Mar. 22, 2018

(54) COLLECTIVE MATRIX FACTORIZATION FOR MULTI-RELATIONAL LEARNING

(71) Applicant: International Business Machines Corporation, Armonk, NY (US)

(72) Inventors: Aurelie Lozano, Scarsdale, NY (US); Hongxia Yang, Sunnyvale, CA (US)

(21) Appl. No.: 15/271,995

(22) Filed: Sep. 21, 2016

(51) Int. Cl. G06N 5/04; G06N 99/00; G06N 7/00; G06F 17/30

(52) U.S. Cl. CPC G06N 5/04; G06F 17/30598; G06N 7/005; G06N 99/005

(57) ABSTRACT

An apparatus, method and computer program product for generating a recommendation using multi-relational learning comprising receiving first multi-relational data for a first relation, receiving second multi-relational data for a second relation associated with the first relation, unfolding the received first multi-relational data into relational matrices based on a relational graph, obtaining co-clustering, related models of the relational matrices, and generating and displaying the recommendation from the relational matrices and the second multi-relational data. In one aspect, the unfolding is performed using hierarchical nonparametric Bayesian collective matrix factorization. In one aspect, the at least two relational matrices comprise commonly shared object types having the same latent membership across the at least two relational matrices. In one aspect, the unfolding further comprises using matrix factorization on the at least two relational matrices, and performing predictive modeling of each relation of the at least two relational matrices.

### FIELD

This disclosure relates generally to systems and methods of collective matrix factorization for multi-relational learning, and particularly for generating a recommendation using multi-relational learning via hierarchical nonparametric Bayesian collective matrix factorization.

### BACKGROUND

Relational learning addresses problems where the data come from multiple sources and are linked together through complex relational networks. Two important goals are pattern discovery (e.g. by (co)-clustering) and predicting unknown values of a relation, given a set of entities and observed relations among entities. In the presence of multiple relations, combining information from different but related relations can lead to better insights and improved prediction. Collective Matrix Factorization (CMF) is a powerful tool for relational learning.

Relative or relational learning is related to the area of relational (co)-clustering, which refers to models on sets of related matrices or tensors where the underlying factorization involves clustering or co-clustering rows and columns in the case of matrices or higher dimensions in the case of tensors. Traditional machine learning methods assume that the data come from a homogeneous source corresponding to a single relation. In real-world problems, however, this assumption is often violated. In addition, the information available on individual entities is often scarce, while the connections among these entities are most relevant for pattern discovery. Examples include citation analysis, link prediction, epidemiology, web analytics and collaborative filtering. Multi-relational learning goes beyond standard methods to analyze the data from multiple relations, allowing dependencies between samples and samples with different distributions, to provide deeper insights into the patterns underlying the multiple relationships and their domains. CMF has emerged as a powerful tool for this purpose. More specifically, relational learning can be cast as the simultaneous factorization of several matrices, where the low-rank representations share parameters. The key idea is that one can simultaneously factor these matrices, sharing parameters among factors, when an entity participates in multiple relations. Experimental evidence suggests that combining information from multiple relations leads to better prediction.

However, the traditional CMF framework has several shortcomings: (i) the model is a point estimate that ignores uncertainty in the posterior distribution over parameters; (ii) strong generalization is not statistically well defined; and (iii) each point in the grid search over hyperparameter values involves learning a CMF on held-out data, which is computationally expensive. One proposal to solve these problems is a hierarchical Bayesian variant of collective matrix factorization (HB-CMF). However, this variant is still restrictive as the factors of rows or columns of one matrix are exactly the same as those of rows or columns of another matrix.

### SUMMARY

A system, method and computer program product to automatically control a machine is presented. The system and method particularly will provide an ability to generate a recommendation by performing multi-relational learning via hierarchical nonparametric Bayesian CMF, abbreviated as MRL-HNBP. The system can also display the recommendation.

In one aspect, there is provided a method for generating a recommendation using multi-relational learning comprising receiving at a processing device, first multi-relational data for a first relation, receiving at the processing device, second multi-relational data for a second relation associated with the first relation, unfolding the received first multi-relational data into at least two relational matrices based on a relational graph, obtaining co-clustering, related models of the at least two relational matrices, and generating and displaying the recommendation from the at least two relational matrices and the second multi-relational data. In one aspect, the unfolding is performed using hierarchical nonparametric Bayesian collective matrix factorization. In one aspect, the at least two relational matrices comprise commonly shared object types having the same latent membership across the at least two relational matrices. In one aspect, unfolding comprises using matrix factorization on the at least two relational matrices, and performing predictive modeling of each relation of the at least two relational matrices. In one aspect, obtaining co-clustering further comprises performing cluster analysis and imputing missing values for the at least two relational matrices. In one aspect, the method further comprises performing interference with Gibbs sampling for the at least two relational matrices. In one aspect, the method further comprises performing sparse point estimation for the at least two relational matrices.

In a further aspect, there is provided an apparatus for generating a recommendation using multi-relational learning. The apparatus comprises:

a memory storage device storing a program of instructions;

a processor device receiving said program of instructions to configure said processor device to: receive first multi-relational data for a first relation, receive second multi-relational data for a second relation associated with the first relation, unfold the received first multi-relational data into at least two relational matrices based on a relational graph, obtain co-clustering, related models of the at least two relational matrices, and generate and display the recommendation from the at least two relational matrices and the second multi-relational data. In one aspect, unfold is performed using hierarchical nonparametric Bayesian collective matrix factorization. In one aspect, the at least two relational matrices comprise commonly shared object types having the same latent membership across the at least two relational matrices. In one aspect, unfold comprises using matrix factorization on the at least two relational matrices, and performing predictive modeling of each relation of the at least two relational matrices. In one aspect, obtain co-clustering further comprises performing cluster analysis and imputing missing values for the at least two relational matrices. In one aspect, the processor is further configured to perform interference with Gibbs sampling for the at least two relational matrices. In one aspect, the processor is further configured to perform sparse point estimation for the at least two relational matrices.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 depicts a plate represe ion of the hierarchical nonparametric Bayesian CMF model in one embodiment;

FIG. 2 depicts a computer-implemented method 100 for determining a recommendation by performing multi-relational learning using hierarchical nonparametric Bayesian collective matrix factorization according to one embodiment;

FIG. 3 shows an illustrative example of the computer-implemented method 100 according to one embodiment;

FIG. 4 depicts an embodiment in which the method of FIG. 1-2 is used for Targeting Potential Customers;

FIG. 5 depicts an embodiment in which the method of FIG. 1-2 is used for Movie Rating Predictions;

FIG. 6 depicts an embodiment in which the method of FIG. 1-2 is used for Image Classification;

FIG. 7 depicts an embodiment in which the method of FIG. 1-2 is used for Music Classification;

FIG. 8 depicts an embodiment in which the method of FIG. 1-2 is used for Watson Candidate-Answer Scoring; and

FIG. 9 depicts an exemplary hardware configuration for performing methods for implementing a hierarchical nonparametric Bayesian CMF model to perform relational prediction in one embodiment.

### DETAILED DESCRIPTION

A system and method for determining a recommendation by using a nonparametric hierarchical Bayesian model, abbreviated as MRL-HNBP, that frames a large number of relational learning problems and improves on existing collaborative factorization models is presented. MRL-HNBP achieves this, in one embodiment, by (i) making more reasonable assumptions, (ii) enabling co-clustering and prediction analysis within a unified framework and (hi) allowing for the estimation of entire missing rows or columns is presented. The method significantly improves the prediction power, e.g., recommendation determination, of statistical modeling through leveraging/sharing information in a more sensible way, and enables entities from multiple channels have both shared relations as well as their specific features relations.

In particular, the abstract objects associated with each dyadic matrix are treated as random variables sampled from the independent Dirichlet process (DP). To embed the relation between these matrices, the random variables corresponding to the commonly shared object type are forced to have the same latent membership in the joint DP. In one embodiment, effective algorithms are used for computation. This formulation is also extended to collective tensor factorization. The methods for performing multi-relational learning via hierarchical nonparametric Bayesian CMF (MRL-FINBP) described herein exploit the correlations among different entity types and relations that can improve prediction performance. The promising results of the MRL-HNBP come from both the flexible model setup and the inference schemes, for example, extension of the exact block Gibbs. MRL-HNBP MAP converges faster than the Gibbs inference.

Accordingly, MRL-HNBP, through sharing membership among the same entities across matrices and learn relations within matrices by hierarchical co-clustering is presented. Further, a model that contains a prior based on a hierarchical Dirichlet process (HDP), which assumes independent DP mixture priors for the means and covariances of row and column factors within a matrix is presented. An embodiment of the model incorporates (co-)clustering and prediction analysis in a single unified framework, and allows for the estimation of entire missing row or column vectors in a matrix.

In one embodiment, factors of the same entity across the matrices are not forced to be the same, but instead these factors share the same membership. Further, in one aspect, factors for rows and columns of a matrix are clustered simultaneously to learn relations within a matrix. To obtain a more robust consensus in co-clustering, cluster means and covariances of the factors rather than factors themselves can be used. In this approach, factors assigned to the same cluster are allowed to share the same characteristics rather than constraining them to be equal. To avoid pre-specifying the number of co-clusters, independent DP priors can be specified for the mean and covariance of the row and column clusters. Thus, the numbers of row- and column-clustered distributions are unbounded a priori; the actual numbers of clusters can be learned a posteriori from observations.

Multi-relational learning through CMF is based on the following. Relational data consist of entities and relations between them. A relational schema defines the structure among a set of relations. Abstractly, a relational schema can he viewed as a collection of t entity-types A₁ . . . , Aₜ along with a list of relations, each represented by a data matrix. λᵢ˜λⱼ denotes that there is a relation between entities of type i and those of type j. Assuming that there are m entities of type i and n entities of type j, such a relation is specified by a m×n relation matrix.

In one embodiment, for example, entity types are authors, words and papers, and their corresponding data matrices indicate authorship and word count. Assume that there are in entities of type i. Each matrix involves two entity-types, one for the rows and another for the columns. Each relational matrix can be fitted as the product of latent factors Xᵢⱼ≈∫(U_{i.}V_{i.}′), where U_{i.}∈Rⁿ^{ᵢ}^{×k} and V_{j.}∈Rⁿ^{ⱼ}^{×k} for k∈{1,2, . . . }. In one embodiment, Aⱼ can participate in more than one relation, thus the model reserves the membership and its corresponding base measure of Uᵢ for modeling a specific relation. The models can have the flexibility that, for example, to have relations with different latent dimensions, or to have more than one relation between Aᵢ and Aⱼ without forcing the same value of Aᵢ and Aⱼ to be predicted for each relation.

DP mixture models can be described as follows. In a Bayesian mixture model, the true density of the response Y can be written as a mixture of parametric densities, conditioned on a hidden parameter θ. For example, in a Gaussian mixture, θ corresponds to the mean μ and variance σ². The marginal probability of an observation is given by a continuous mixture, f(y)=∫_{T}f(y|θ)P(dθ), where T is the set of all possible parameters and the prior P is a measure on that space. The DP models uncertainty about the prior density P. If P is drawn from a DP, then it can be analytically integrated out of the conditional distribution of θₙ given θ_{1:(n-1)}, where θₙ denotes the nth parameter for observation yₙ. Specifically, the random variable Oₙ has a Polya urn distribution, and the clustering property of the joint distribution of θ_{1:n} where there is a positive probability that each θᵢ will take on the value of another θⱼ, leading some of the parameters to share values. This equation also makes clear the roles of α and G₀. The unique values of θ_{1:n} are drawn independently from G₀; the parameter a controls how likely θ_{1:n.}G₀ controls the a newly drawn value from G₀ rather than to take one of values from θ_{1:n.}G₀ controls the distribution of a new component.

In a DP mixture, θ is a latent parameter to an observed data point y: That is:

P˜DP(αG₀).

θᵢ˜P, y₁|θₜ˜∫(·|θᵢ).

Examining the posterior distribution of θ_{1:n} given y_{1:n} brings out its interpretation as an ‘infinite clustering’ model. Because of the clustering property, observations are grouped by their shared parameters. Unlike finite clustering models, however, the number of groups is random and unknown. Moreover, a new data point can be assigned to a new cluster that was not previously seen in the data.

Co-clustering has emerged as an important approach for mining dyadic and relational data, where data can be organized in a matrix and rows/columns present symmetrical relations. Researchers propose both hard-partition and soft-partition solutions. In the hard-partition case, rows/columns are assigned to exactly one row/column cluster, while in the soft-partition case, rows/columns have probabilities of belonging to the row/column clusters. The Bayesian co-clustering framework (BCC) assumes two Dirichlet distributions Dir(αₗ) and Dir(α₂) for rows and columns, respectively, given data matrix Y, from which the mixing weights π₁ᵤ and π₂ᵥ for each row u and each column v are generated. A row cluster i and a column cluster/together decide a co-cluster (i, j), which has an exponential family distribution pψ(y|θᵢⱼ), where θᵢⱼ is the parameter of the generative model for co-cluster (i, j). To generate each entry in the data matrix, the model first generates the row and column clusters according to the Dirichlet distribution. The value of the current entry is then generated according to the corresponding rowcolumn-cluster distribution. The BCC is a generative model which can be used to predict unseen data.

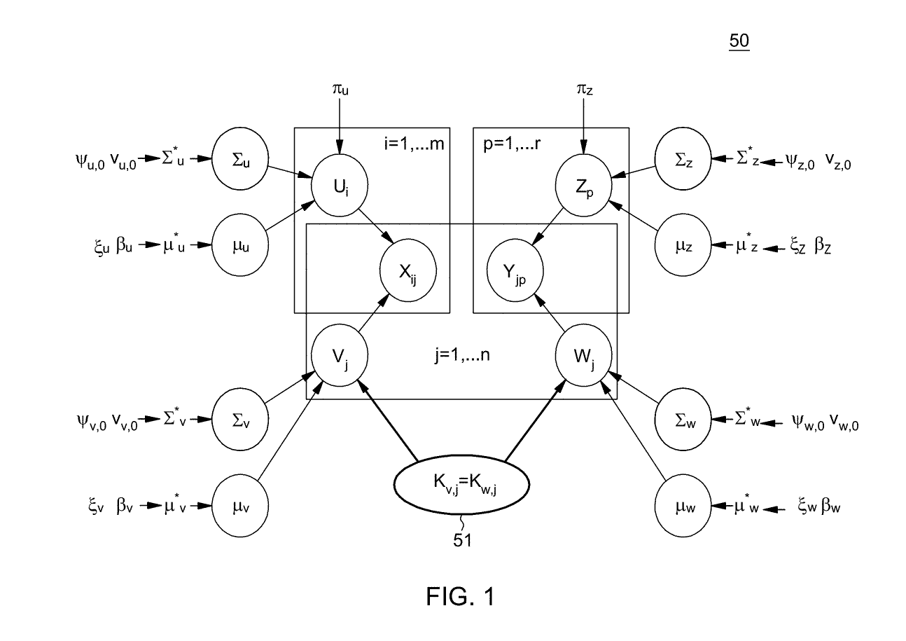

FIG. 1 provides a graphic representation of the hierarchical nonparametric Bayesian CMF model 50, that is, a graph based representation of the underlying model in accordance with one embodiment.

A model for a three-entity-type schema Aₗ˜A₂˜A₃ in one embodiment is presented. As shown in FIG. 1, the method 50 represents the relational data concerning Aₗ and A₂ as an m×n matrix X: rows of X correspond to entities of type A₁, columns of X correspond to entities of type A₂ and the element A^{ij} indicates whether a relation exists between entities i and j. A low-rank factorization of X has the form X≈f(UV′), with factors U ∈R^{m×k}' and V ∈R^{n×k}. Here, k>0 is the rank and f is a possibly nonlinear link function. Similarly, the relational data concerning A₂ and A₃ can be represented as an n×r matrix Y. Embed the entities in a k′-dimensional space, by factoring an indirect representation of the matrix Y≈g(W Z′) with W ∈R^{n×k′}and Z ∈R^{r×k′}. Given parameters F=(U, V, W, Z), and data D=(X, Y), the likelihood of each matrix is

$$\begin{matrix}p ( X \vert U , V , I ) = {\prod }_{i = 1}^{m} {\prod }_{j = 1}^{n} {[ {p}_{X} ( {X}_{ij} \vert {U}_{i \cdot } {V}_{j \cdot }^{′} ) ]}^{{I}_{ij}} , & ( 1 ) \\ p ( Y \vert W , Z , \tilde{I} ) = {\prod }_{j = 1}^{n} {\prod }_{p = 1}^{r} {[ {p}_{Y} ( {Y}_{jp} \vert {W}_{j \cdot } {Z}_{p \cdot }^{′} ) ]}^{{\tilde{I}}_{jp}} . & ( 2 )\end{matrix}$$

where pₓ, and p_{y} are distributions from exponential family and they need not be from the same exponential family. The fixed weights Iᵢⱼ ∈{0, 1} and Ĩⱼₚ ∈{0,1} allow for missing data: set a weight to zero when the corresponding value in the data matrix is unobserved.

Maximizing the product of Equations (1) and (2) with respect to the factors F is an instance of CMF. A multivariate normal prior can be placed on each row of U:

$$p ( U \vert {Θ}_{U} ) = {\prod }_{i = 1}^{m} N ( {U}_{i \cdot } \vert {μ}_{U , i} , {Σ}_{U , i} ) ,$$

where N(·|∥_{U,i}, Σ_{U,i}) is a Gaussian with mean vector μ_{U,i} and covariance matrix Σ_{U,i}. The following can he the joint prior for μ_{U,i} and Σ_{U,i}:

$$( {μ}_{U , i} , {Σ}_{U , i} ) ∼ η \{ {π}_{U} {δ}_{0} ( {μ}_{U , i} ) IW ( {v}_{U , 0} , {Ψ}_{U , 0} ) + ( 1 - {π}_{U} ) D \} , \\ {π}_{U} ∼ Beta ( 1 , {α}_{U} ) , D ∼ DP ( {α}_{U} {D}_{U , 1} ) , \\ {D}_{U , 1} ≡ N ( {ξ}_{U , 1} , \frac{{Σ}_{U , i}}{{β}_{U}} ) IW ( {v}_{U , 1} , {Ψ}_{U , 1} ) ,$$

where η is the normalizing constant, δ₀(μ_{U,i}) indicates that the random variable μ_{U,i} has a degenerate distribution with all its mass at 0 (degenerate distribution accounts for data sparsity) and IW is the abbreviation of the inverse-Wishart distribution. ξ_{U,1}, Σ_{U,i}, β_{U}, ν_{U,0}, Ψ_{U,0}, ν_{U,1} and Ψ_{U,1} are hyper-priors. Thus, with probability π_{U} a row is shrunk toward zero and with probability 1−π_{U} the row is shrunk toward a non-zero normal-inverse-Wishart prior. Denote K_{V,j}=l if the ith row of V is clustered in the l'th latent cluster and K_{w,j}=l′ if the j'th row of W is clustered in the l'th latent cluster. The priors over V, W and Z are defined similarly, except that V and W share the same membership (or K_{V,j}=K_{W,j} for the joint DP) as depicted at 51 in FIG. 1.

Since the DP prior implies that D is almost surely discrete, the prior will automatically group the m coefficient-specific hyperparameters {μ_{U,i}Σ_{U,i}} into L clusters {μ_{U,l}^{*}, Σ_{U,l}^{*}}, with L≦m. One of these clusters will most likely correspond to μ_{U,l}^{*}=0, while the other clusters will not have zero means. By denoting that K_{U,i}=l if the i'th row is clustered in the l'th latent cluster, a prior can be seen more clearly through the equivalent stick-breaking form:

$${K}_{U , i} ∼ {\sum }_{l = 1}^{∞} {π}_{l} {δ}_{l} , \\ ( {μ}_{U , l}^{*} , {Σ}_{U , l}^{*} ) ∼ \{ \begin{matrix}{η}_{0} {δ}_{0} ( {μ}_{U , 0}^{*} ) IW ( {v}_{U , 0} , {Ψ}_{U , 0} ) , for l = 1 \\ {η}_{1} N ( {μ}_{U , l}^{*} ; {ξ}_{U , 1} , \frac{{Σ}_{U , i}}{{β}_{U}} ) IW ( {v}_{U , 1} , {Ψ}_{U , 1} ) , l > 1\end{matrix} .$$

Unlike existing methods for analyzing dyadic matrices, the model run at the computer system incorporates clustering and prediction analysis in a unified framework. Clustering analysis of particular interest includes two types of unsupervised analysis, one-way clustering and co-clustering. One-way clustering groups the instances of each abstract object into small clusters based on the observed data. For instance, authors may be clustered based upon their co-authorship relationships (observed in dyads authorarticle) and the word representation of their authored articles (observed in dyads articleword). In many applications, it is also critical to exploit the duality between two abstract objects through co-clustering both dimensions of a dyadic matrix. For example, similar author groups and their relationship can be identified with article clusters.

Note that the hidden clusters are characterized by (μ_{U,l}^{*}, Σ_{U,l}^{*}), l=1, . . . , L for object U, where L is the number of clusters in U. Given the model parameters obtained from the training process, the posterior probability of Uᵢ be characterized by (μ_{U,l}^{*}, Σ_{U,l}^{*}) is given as:

Pr(K_{U,i}=l|. . . )∝π_{U,l}N(U_{i.}|μ_{U,l}^{*}, Σ_{U,l}^{*}), (3)

where π_{U,l} is the prior robability of cluster (μ_{U,l}^{*}, Σ_{U,l}^{*}). For co-clustering analysis, the probability of a pair of instances (Uᵢ, V ⱼ) belonging to a co-cluster can be obtained by computing the following joint probability:

Pr[K_{U,i}=l₁, K_{V,u}=l₂| . . . ]=Pr(K_{U,i}=l₁| . . . )Pr(K_{V,j}=l₂| . . . ),

where Pr(K_{U,i}=l| . . . ) is calculated as in Equation (3). Fur the ore, the above two-way co-clustering can be extended to the multiple-way case, which just repeats the computation of the joint distribution along multiple types of abstract objects.

Although there has been interest in imputing matrix entries that are missing at random, few existing models have capability to estimate entire missing column or row vectors. Since in the formulation described herein, the model takes into account the observed information from multiple relational dyadic matrices, it is possible to predict an entire row or column vector in one dyadic matrix given the information observed from the other dyadic matrix. For example, given an article with the representation of a dyadic vector articleword (Yⱼₗ, . . . , Y_{jK}), the row vector (\tilde{X}₁ⱼ, . . . , \tilde{X}_{Ij}) which denotes the possible authors of this article can be estimated, as discussed below. In the example of predicting authors for a given article, one can convert the continuous prediction results \tilde{X}ᵢⱼ to obtain binary authorship via any reasonable link functions or thresholding.

The observed dyads Xᵢⱼ and Yⱼₖ are represented by two matrix factorization models resulting in a way to recover missing values among the observed dyadic matrices. More specifically, in the qth sampling iteration, given the achieved latent space {μ_{U}^{*}, Σ_{U}^{*}}, {μ_{V}^{*}, Σ_{V}^{*}} and the borrowed membership K_{V,j}, the factorization effects Uᵢ^{(q)}, Vⱼ^{(q)} can be obtained, and the missing entry Xᵢⱼ is computed through Monte Carlo integration as in equation 4),

$${\tilde{X}}_{ij} = \frac{1}{Q} {\sum }_{q = 1}^{Q} ( {U}_{i \cdot }^{( q )} {V}_{j \cdot }^{{( q )}^{′}} ) , for i = 1 , … m , \qquad ( 4 )$$

where Q is the number of iterations after discarding the burn-in period. Note that in the MRL-HNBP framework, estimating missing values at random or estimating entire for/column vectors are treated equally. As the particular marginal likelihood function to obtain Xᵢⱼ is not obtained, Monte Carlo integration is an efficient method and is performed as calculating equation (4) in every iteration to achieve a relatively good estimation of those missing values.

Posterior computations can be performed in accordance with interference via Gibbs sampling updates and sparse point estimation via hybrid Gibbs algorithm. The algorithms presented herein can be applied to both matrices and tensors. If data matrices are binary, data can initially be augmented by assuming the outcome Xᵢⱼ^{*}=1 occurs when a latent variable, Xᵢⱼ>0. Assume Xᵢⱼ=U_{i.}V_{j.}′+εᵢⱼ where εᵢⱼ˜N(0, σ_{q}²) and σ₁²˜Inv−Gamma(v/2,v/2φ²)

This scale mixture of normals with φ²=π²(V−2)/3v and v=7.3 is a near exact representation of the logistic distribution. The data augmentation approach allows this algorithm to be readily modified for other regression models, such as probit. In one embodiment, two simple linear models can be used after the link function transformation, in accordance with an exact blocked Gibbs sampling algorithm that proceeds through the below steps based on the following:

Xᵢⱼ=U_{i.}V_{j.}′+εᵢⱼ, εᵢⱼ˜N(0,σ₁²)

Yⱼₚ=W_{j.}Z_{p.}′+εⱼₚ, εⱼₚ˜N(0,σ₂²)

wherein U_{i.} is updated through:
(STEP 1) Sample U from multivariate normal distribution:

$${M}_{{U}_{i}} = \frac{1}{{σ}_{1}^{2}} {\sum }_{j} {V}_{j \cdot }^{′} {X}_{ij} + {\sum }_{U , i}^{- 1} {μ}_{U , i}^{′}$$

$${V}_{{U}_{i}} = {( \frac{1}{{σ}_{1}^{2}} {\sum }_{j} {V}_{j \cdot }^{′} {V}_{j \cdot } + {\sum }_{U , i}^{- 1} )}^{- 1}$$

$${U}_{i} ∼ N ( {V}_{{U}_{i}} {M}_{{U}_{i}} , {V}_{{U}_{i}} ) .$$

(STEP 2) Extending the exact block Gibbs sampler from step 1 above, the joint prior distributions of K_{U,i} and a latent variable v_{U,i} can be written as:

$$f ( {K}_{U , i} , {v}_{U , i} \vert π ) = {\sum }_{l : {π}_{U , l} > {v}_{U , i}} {δ}_{l} ( \cdot ) = {\sum }_{l = 1}^{∞} 1 ( {v}_{U , i} < {π}_{U , l} ) {δ}_{l} ( \cdot ) .$$

Implementing an exact block Gibbs sampler with steps of:
(i) Sampling v_{U,i}˜uniform (0,π_{K}_{_{U,i}}), for i=1, . . . , m with π_{U,t}=VₜΠ_{s<t}(1−Vₛ).
(ii) Sampling the stick-breaking random variables V₁˜beta(1+mₗ, α_{U}+Σ_{s-l+q}^{L}mₛ), for l=1, . . . , L with L the minimum value satisfying π_{U,l}+ . . . +π_{U,L}>1−min{ν_{U,i}}. mᵢ is the number of components clustered into the l'th cluster.
(iii) Sampling μ_{U,l}^{*} for l=1, . . . , L by
   (a) For l=1, since the prior probability for μ_{U,l}^{*} has unit probability mass at 0, the posterior distribution still has probability mass at 0.
   (b) For 2≦l≦L,

M_{U,l}=Σₖ_{_{U,i}}₋ₗΣ_{U,l}^{*-1}U_{i.}+β_{U}Σ_{U,l}^{*-l}ξ, V_{U,l}=(mₗΣ_{U,l}^{*-l}+β_{U}Σ_{U,l}^{*-l})^{-l}, μ_{U,l}^{*}˜N(V_{U,l}M_{U,l}, V_{U,l}).
(iv) Sampling Σ_{U,l}^{*} for l=1, . . . , L by
   (a) For l=1, Σ_{U,l}^{*}˜IW(mₗ+ν_{U,0}, Ψ_{U,o}+Σ_{K}_{_{U,i}}₌₁(U_{i.}−μ_{U,l}^{*})(U_{i.}−μ_{U,l}^{*})′).
   (b) For 2≦l≦L, Σ_{U,l}^{*}:IW(mₗ+ν_{U,l}+1, Ψ_{U,l}+Σ_{K}_{_{U,i}}₌ₗ(U_{i.}−μ_{U,1}^{*})(U_{i.}−U_{U,l}^{&})′+β_{U}(μ_{U,l}^{*}−ξ_{U,l})(μ_{U,l}^{*}−ξ_{U,l})′).
(v) Sampling K_{U,i} for i=1, . . . , m from the multinomial conditional with Pr(K_{U,i}=l| . . . )∝1(ν_{U,i}<π_{U,l})N(U_{i.}|μ_{U,l}^{*}, Σ_{U,l}^{*}).

V_{j.} and W_{i.} are sampled similar to U_{i,} with the only difference that Pr(K_{V,j}=l| . . . )∝1(ν_{V,i}<π_{V,l})N(V_{j.}|μ_{V,l}^{*}, Σ_{V,l}^{*})N(W_{j.}|μ_{W,l}^{*}, Σ_{W,l}^{*}), and W_{j.} share the same membership with V_{j.} Z_{p.} is updated simlar to U_{i.}.

Sparse point estimation via hybrid Gibbs algorithm can be performed in accordance with Maximum A Posteriori (MAP) inference, which consists of finding the parameters minimizing the negative log-posterior: L=−log (U, V, W, Z, |X, Y, I, Ĩ, Θ_{U}, Θ_{V}, Θ_{W}, Θ_{Z}). One can take advantage of the convexity and decomposability properties of the negative log-posterior through the use of alternating optimization implemented via Newton updates. Note that hyperparameters can be fixed (as opposed to variable or random) and ignoring terms that do not depend on the factors, the negative log-posterior can be written as:

L=−log p(X|U, V, I)−log p(Y|W, Z, I^{~})

−log p(U|Θ_{U})−log p(V|Θ_{V})

−log p(W|Θ_{W})−log p(Z|Θ_{Z})

Typically the probabilities involved in the negative log-posterior belong to the exponential family; in particular these are Gaussians, so that the negative log-posterior L is convex with respect to each of its arguments. Hence it can be minimized using alternative optimization by cycling through U, V, W, Z, respectively. In addition, since the negative log posterior L is decomposable, the alternating optimization can be efficiently implemented via Newton updates that reduce to row-wise optimization.

Then, there is denoted by Q(U i.) the ith row of ∇_{U}L, the gradient of the loss with respect to U. Then, there similarly defined: Q(Vj.), q(Wj.), q(Zp.). Using matrix calculus, there is obtained:

q(Uᵢ)=σ₁⁻²Iᵢ ⊙((Ui·V′)V+(Ui·−μ_{U,i})Σ_{U,i}⁻¹

q(Vⱼ)=σ₁⁻²Iⱼ ⊙((UVⱼ^{′})−Xj·)′U+(Vⱼ·−μ_{V,j})Σ_{V,j}⁻¹

q(Wⱼ)=σ₂⁻²Ĩⱼ ⊙((WⱼZ^{′})−Yj·)Z+(Wⱼ·−μ_{W,j})Σ_{W,j}⁻¹

q(Zₚ)=σ₂⁻²Ĩₚ ⊙((WZₚ^{′})−Yp·)′W+(Zₚ·−μ_{Z,p})⇄_{Z,p}⁻¹

where ⊙ denotes the element-wise product, The Hessian ∇_{U}² L respect to U is a block-diagonal matrix, where each non-zero block corresponds to a row of U. Hence, the Newton direction for U, [∇_{U}L][∇_{U}²L]⁻¹ reduces to updating each row Uᵢ, using the direction [q(Ui.)][q¹(Ui)]⁻¹. More precisely, the Newton step for U_{i.} is: Uᵢ^{new}=U_{i.}−γ[q(Uᵢ) ][q^{′}(Uᵢ)]⁻¹, where γ>0 is a small step size, for example, chosen via line search using, e.g., the Armijio rule. Similar arguments apply for V_{j.}, W_{j.}, Z_{p.}. Using matrix calculus, there is then computed:

q^{′}(U_{i.})=σ_{q}⁻²V^{′}diag (Ii.)V+Σ_{U,i}⁻¹

q^{′}=σ₁⁻²U^{′}diag (Ij)U+Σ_{V,j}⁻¹

q^{′}=σ₂⁻²Z^{′}diag (Ĩⱼ.)Z+Σ_{W,j}⁻¹

q^{′}=σ₂⁻²W^{′}diag (Ĩₚ.)W+Σ_{Z,p}⁻¹

Each Newton step with respect to U, V, W, Z, respectively, decreases the loss, which is lower bounded. Hence, alternating single Newton steps guarantee convergence to a local mittimizer. In view of the block-diagonal structure of the Hessian, one may think that there are no interactions between different rows of a factor. However, this is not the case: the interactions are indirect through another factor. For instance, the rows of U interact through their effect on V, etc.

In the above procedure, the update of Uᵢ (in Step 1) can be replaced by one Newton step for Uᵢ. Typically the most costly step in the above is not inverting the Hessian but rather computing the gradient. The cost of the latter can be reduced via stochastic approximation where the updates are similar to the above, except that they are computed on a subset of observed relations picked randomly at each iteration. One example heuristic for picking the subsets of relations is to sample the data non-uniformly without replacement from the distribution induced by weights I and Ĩ. For instance, for a row Uᵢ,: the probability of selecting X_{i,j} is I_{i,j}/Σₗl_{i,i}. In the limit, one entity can be sampled at a time, which can result in an online algorithm, offering the possibility of dealing with each relation as it appears without having to store it across iterations. This will not affect the computation operations but will esult in more efficiency for storage.

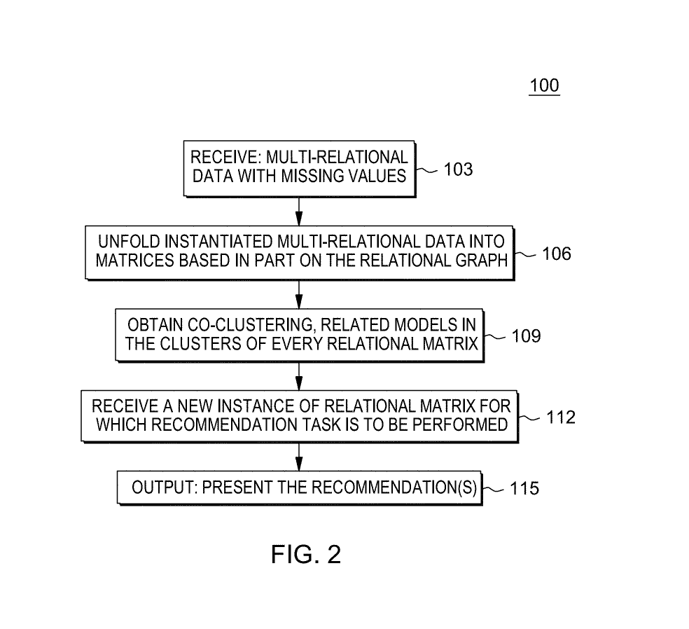

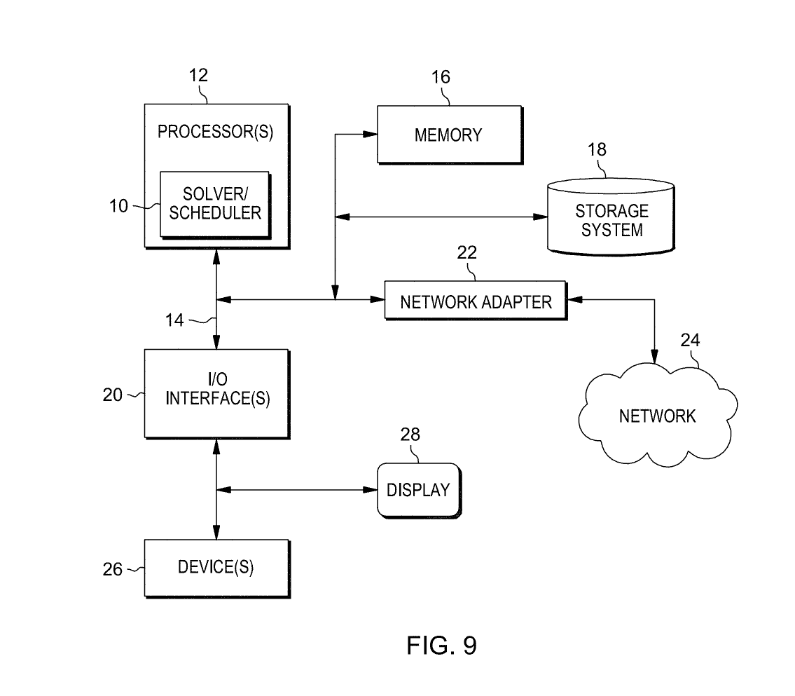

As shown in FIG. 2, there is provided a computer-implemented method 100 for multi-relational learning via hierarchical nonparametric Bayesian collective matrix factorization. Method 100 may be embodied within a computer system such as shown in FIG. 9.

In the method 100 of FIG. 2 there is first received at the computer system input data of multi-relational data with missing values 103. This input of instantiated multi-relational data 103 is unfolded into matrices based in part on the relational graph 106. Then, at 109, there is performed a co-clustering of related models in the clusters of every relational matrix. In one embodiment, commonly shared object types are forced to have the same latent membership across the relational matrices. A new instance of relational matrix for which a recommendation is to be generated is received at 112. For example, to maximize a profit of new products, a recommendation in social media. Finally, the recommendation(s) are output and presented 115 via a user interface display.

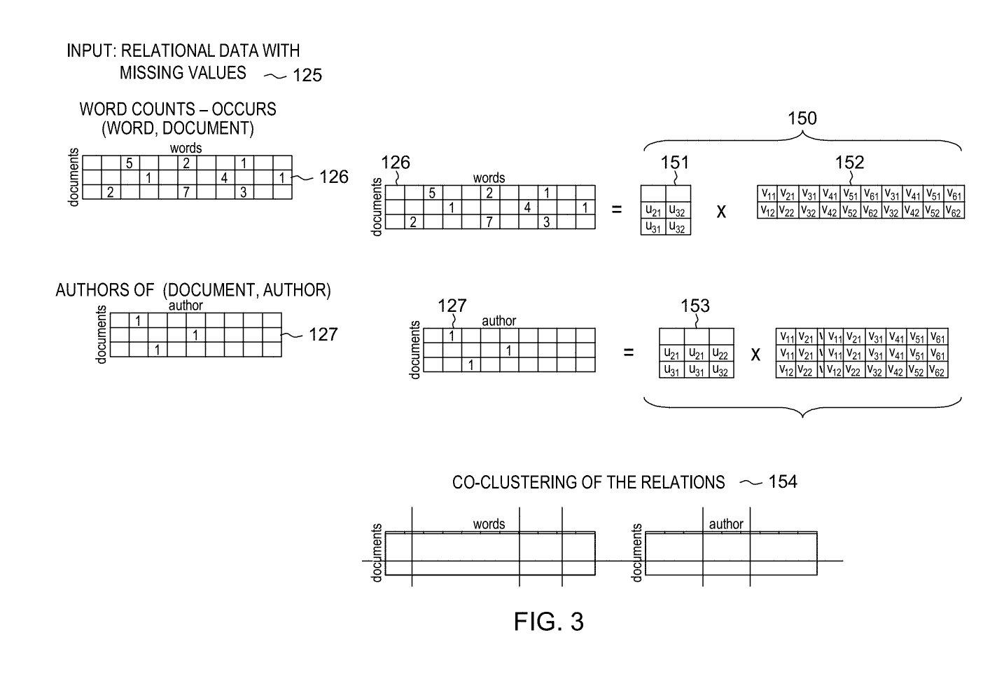

In a conceptual view of FIG. 3 showing an application of the method 100 depicted in FIG. 2, the input 125 comprises two matrices. In an example application of the method for predicting authorship of certain articles based on article-word co-occurrence features, a first upper matrix 126 may comprise Word counts Occurs (word, document), and the second lower matrix 127 may comprise Authors of (document, author). For example, a database or other memory storage device may include data structures including a list of authors (a₁, a₂, . . . aₙ₁), a list of papers (p₁, p₂, . . . , pₙ₂), and a list of words (w₁, w₂, . . . , wₙ₃). The embodying of these data structures are on a computer readable medium, the data structures comprising: data objects, each data object including a vector with a plurality of elements of a same type; feature matrices, there being a feature matrix corresponding with each data object; relationship matrices describing pairwise relationships between the data objects; and weighting matrices. These matrices are inputs, e.g., age, gender or other demographic information matrices.

Implementing the methods above, the output 150 includes a first Matrix 151 illustrating a Matrix factorization and predictive model of each relation (to fill-in up to entire missing rows/columns) 152. Also, a second matrix 153 illustrating the Co-clustering of the relations 154, e.g., blocks of documents/words/authors after re-arranging the ordering, is generated. In one embodiment, the missing values in matrix 152 are imputed using the model to estimate entire missing column or row vectors. Since the model takes into account the observed information from multiple relational dyadic matrices, it is possible to predict an entire row or column vector in one dyadic matrix given the information observed from the another dyadic matrix. The steps for computing matrix 151 may include performing the posterior computations in accordance with interference via Gibbs sampling updates and sparse point estimation via exact blocked Gibbs algorithm including methods of STEP 1 and STEP 2 as discussed above, and implementing exact block Gibbs sampler steps (i)-(v) described herein above. Further, the computations for generating matrices 152, 153 may include the further steps that include sampling V_{j.} and W_{j.} sampled similar to Uᵢ.

In one embodiment, the above-described equations for computing these matrices do not require any specific ordering as long as the Markov Chain Monte Carlo (MCMC) is convergent.

In one embodiment, the two matrices 151, 153 do not need to be identical. Instead information may be shared by imposing that the two-cluster memberships for a given document are the same. In this manner, the method automatically estimates missing values; automatically co-clusters relations; is scalable to large scale data sets through Bayesian Modeling; and minimizes the inconsistency to derive optimal functions.

The present method may be implemented on a general purpose computer or a specially adapted machine. Typically, a programmable processor will execute machine-readable instructions stored on a computer-readable medium. In other cases, the method will be implemented using application specific hardware. The present invention has significant versatility, and can be applied to a wide range of applications involving relational data. Examples include, but are not limited to: (1) Clustering web documents using both text and link information; (2) Rating prediction in a recommendation system; (3) Community detection in social network analysis; and (4) Discovering gene patterns in bioinformatics application.

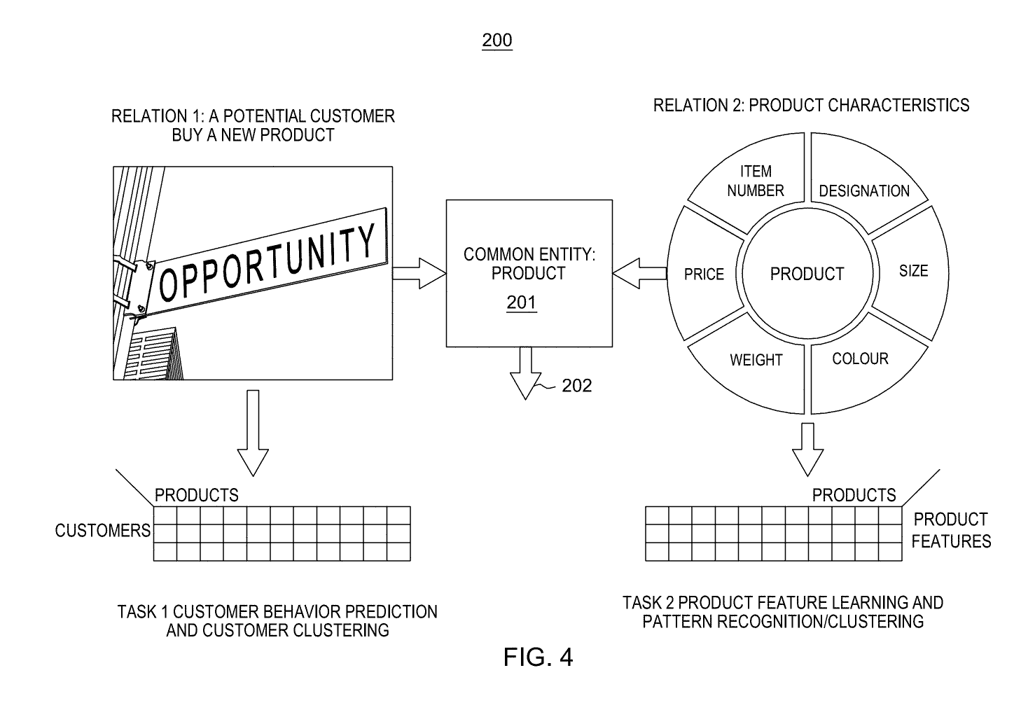

FIGS. 4-8 are particular examples of applications using the present disclosure. In each of the particular examples, the system and method handles concurrent multi-relational prediction of entities across multiple channels based on rich information. The power of statistical modeling through leveraging/sharing information significantly improves prediction.

The method includes outputting a high-quality recommendation(s) to a user of multi-relational network (e.g., social network, enterprise transactions) by operating: 1) (co-)clustering multi-relational data; 2) transferring/sharing information across multi-relational data matrices systematically (latent space modeling, soft clustering); 3) determining weighted values for the mixture of the latent distributions for the clusters, e.g., using exact block Gibbs sampling step (i); 4) generating a weighted mixture model of the relations based on the nonparametric Bayesian models, e.g., using exact block Gibbs sampling step (v); and 5) recommending to the user based on the statistical prediction modeling. In one embodiment, efficient Hybrid Markov Chain Monte Carlo (MCMC) utilizing optimization methods are implemented for the Hierarchical Bayesian modeling. The algorithm can be scalable to a high dimensional data.

In a first example, FIG. 4 illustrates an embodiment in which the multi-relational learning methods of the present disclosure are used to Target Potential Customers 200 for marketing products. The input includes a first relational matrix, Relation 1, of a potential customer buying a new product. The input further includes a second relational matrix, Relation 2, of product characteristics for the new product of the potential customer. The output comprises Task 1, customer behavior prediction and customer clustering, and Task 2, product feature learning and pattern recognition/clustering. The relational matrix of Task 1 comprises rows of customers and columns of products for modeling customer behavior prediction and customer clustering. The relational matrix of Task 2 comprises rows of product features and columns of products for modeling product feature learning and pattern recognition/clustering. The common entity is a product 201. Such product features/characteristics can include price, item number, designation, size, weight, and/or color. Use of the present methods for multi-relational learning may generate an output recommendation 202 and improve prediction of popularity of a new product. This can be used to attract customers through adding more features of the products.

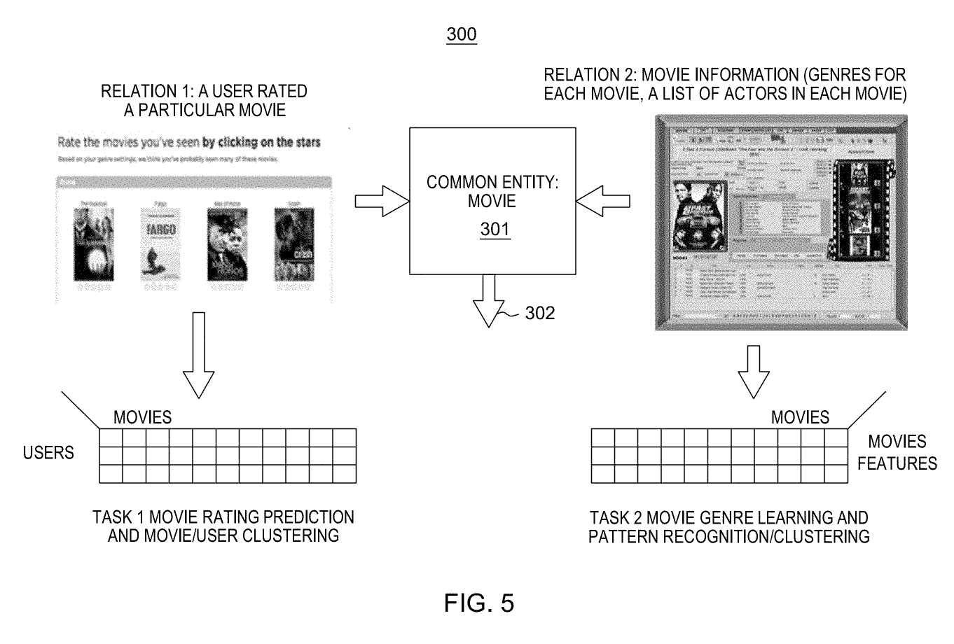

In a second example, FIG. 5 illustrates an embodiment in which the multi-relational learning methods are used for Movie Rating Predictions 300. The input includes a first relational matrix, Relation 1, of user ratings for particular movies. The input further includes a second relational matrix, Relation 2, of movie characteristics. The output comprises Task 1, movie rating prediction and user clustering, and Task 2, movie genre learning and pattern recognition/clustering. The relational matrix of Task 1 comprises rows of users and columns of movies. The relational matrix of Task 2 comprises rows of movie features, e.g., genres, list of actors, etc., and columns of movies. The common entity 301 is movie. An output recommendation 302 can be generated regarding prediction of a popularity of a new movie. This can attract movie-goers through adding more features of the movies.

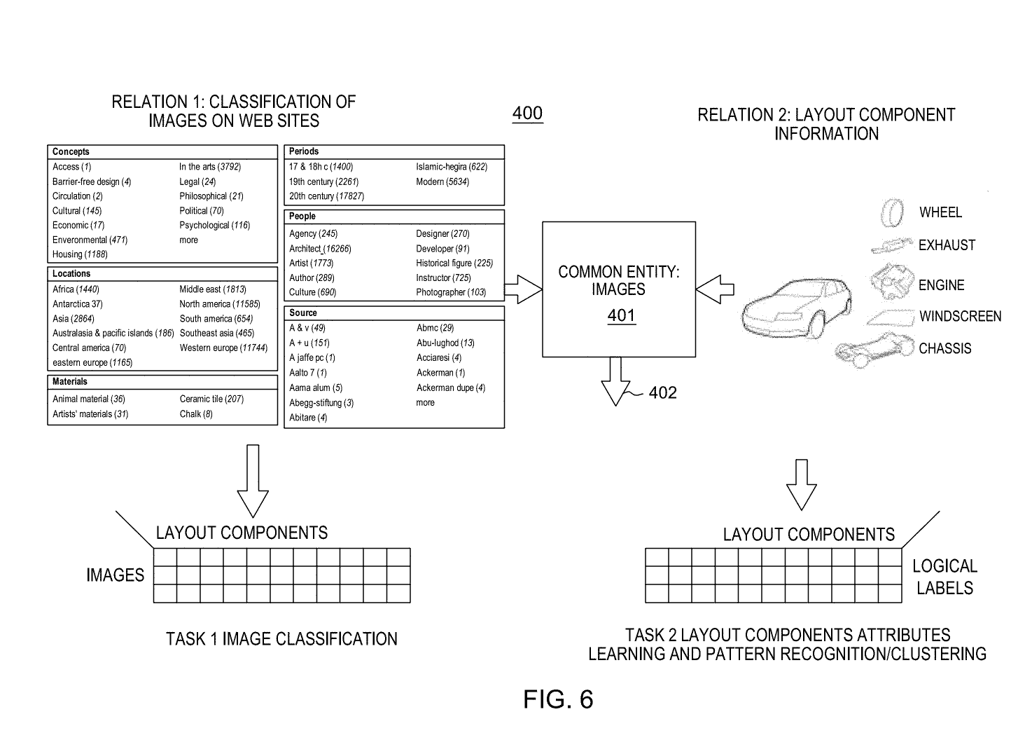

In a third example, FIG. 6 illustrates an embodiment in which the multi-relational learning methods are used for Image Classification 400. The input comprises a first relational matrix, Relation 1, of classification of images on web sites. The input further comprises a second relational matrix, Relation 2, of layout component information. The output comprises Task 1, Image classification, and Task 2, layout components attributes and pattern recognition/clustering. The relational matrix of Task 1 comprises rows of images and columns of layout components. The relational matrix of Task 2 comprises rows of logical labels, and columns of layout components. The common entity 401 is images. The output or the recommendation comprises Task 1, Image classification, and Task 2, layout components attributes and pattern recognition/clustering.

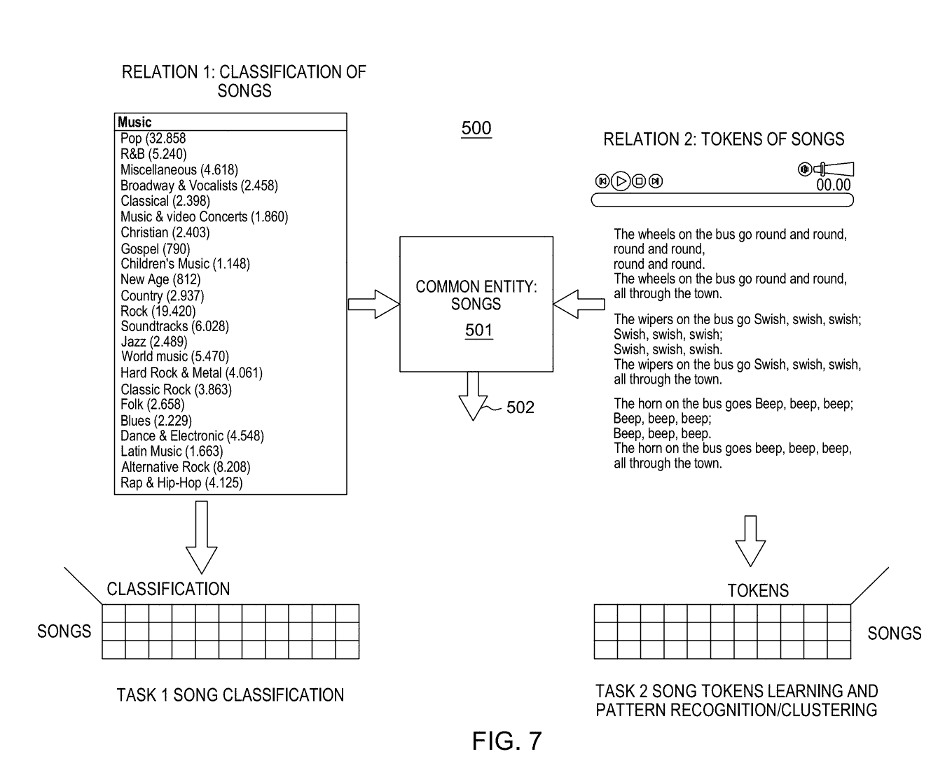

In a fourth example, FIG. 7 illustrates an embodiment in which the multi-relational learning methods are used for Music Classifications 500. The input comprises a first relational matrix, Relation 1, of classifications of songs. The input further comprises a second relational matrix, Relation 2, of tokens of songs. The output comprises Task 1, song classification, and Task 2, song tokens learning and pattern recognition/clustering. The relational matrix of Task 1 comprises rows of songs and columns of classifications of songs. The relational matrix of Task 2 comprises rows of songs and columns of tokens. The common entity 501 is songs. The output or the recommendation comprises Task 1, song classification, and Task 2, song tokens learning and pattern recognition/clustering.

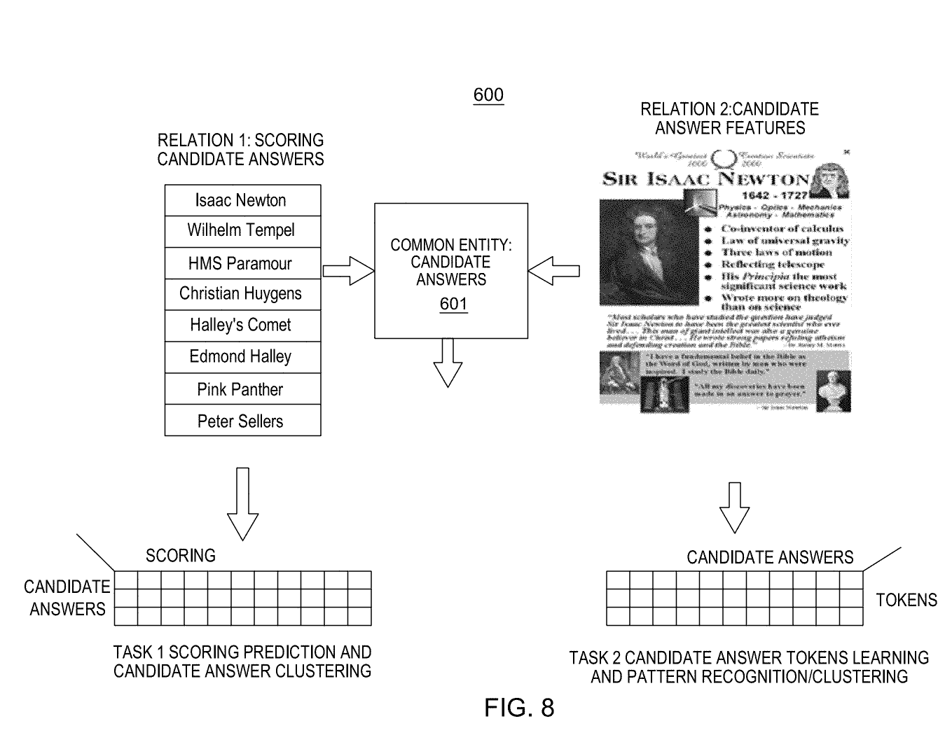

In a further example, FIG. 8 illustrates an embodiment in which the multi-relational learning methods are used for Watson® Candidate-Answer Scoring. The input comprises a first relational matrix, Relation 1, of scoring candidate answers. The input further comprises a second relational matrix, Relation 2, of candidate answer features. The output comprises Task 1, scoring prediction and candidate answers clustering, and Task 2, candidate answer tokens learning and pattern recognition/clustering. The relational matrix of Task 1 comprises rows of candidate answers and columns of scoring. The relational matrix of Task 2 comprises rows of tokens and columns of candidate answers. The common entity is candidate answers; the output recommendation further includes candidate answers.

FIG. 9 illustrates a schematic of an example computer or processing system that may implement a hierarchical nonparametric Bayesian CMF prediction tool in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 9 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for generating a recommendation using multi-relational learning comprising:
receiving at a processing device, first multi-relational data for a first relation;
receiving at the processing device, second multi-relational data for a second relation associated with the first relation;
unfolding the received first multi-relational data into at least two relational matrices based on a relational graph;
obtaining co-clustering, related models of the at least two relational matrices; and
generating and displaying the recommendation from the at least two relational matrices and the second multi-relational data, in response to a query.

2. The method of claim 1, the unfolding is performed using hierarchical nonparametric Bayesian collective matrix factorization.

3. The method of claim 1, wherein the at least two relational matrices comprise commonly shared object types having the same latent membership across the at least two relational matrices.

4. The method of claim 1, the unfolding further comprising:
using matrix factorization on the at least two relational matrices; and
performing predictive modeling of each relation of the at least two relational matrices.

5. The method of claim 1, the obtaining co-clustering further comprising:
performing cluster analysis and imputing missing values for an entire row or column vector of the at least two relational matrices.

6. The method of claim 1, further comprising:
performing interference with Gibbs sampling for the at least two relational matrices.

7. The method of claim 1, further comprising:
performing sparse point estimation for the at least two relational matrices.

8. An apparatus for generating a recommendation using multi-relational learning, the apparatus comprising:
a memory storage device storing a program of instructions;
a processor device receiving said program of instructions to configure said processor device to:
receive first multi-relational data for a first relation;
receive second multi-relation data for a second relation associated with the first relation;
unfold the received first multi-relational data into at least two relational matrices based on a relational graph;
obtain co-clustering , related models of the at least two relational matrices; and
generate and display the recommendation from the at least two relational matrices and the second multi-relational data.

9. The apparatus of claim 8, wherein the unfold is performed using hierarchical nonparametric Bayesian collective matrix factorization.

10. The apparatus of claim 8, wherein the at least two relational matrices comprise commonly shared object types having the same latent membership across the at least two relational matrices.

11. The apparatus of claim 8, the unfold further comprising:
use matrix factorization on the at least two relational matrices; and
perform predictive modeling of each relation of the at least two relational matrices.

12. The apparatus of claim 8, the obtain co-clustering further comprising:
perform cluster analysis and impute missing values for an entire row or column vector of the at least two relational matrices.

13. The apparatus of claim 8, further comprising:
perform interference with Gibbs sampling for the at least two relational matrices.

14. The apparatus of claim 8, further comprising:
perform sparse point estimation for the at least two relational matrices.

15. A computer readable storage medium, tangible embodying a program of instructions executable by the computer for generating a recommendation using multi-relational learning, the program of instructions, when executing, performing the following steps:
receiving at a processing device, first multi-relational data for a first relation;
receiving at the processing device, second multi-relational data for a second relation associated with the first relation;
unfolding the received first multi-relational data into at least two relational matrices based on a relational graph;
obtaining co-clustering, related models of the at least two relational matrices; and generating and displaying the recommendation from the at least two relational matrices and the second multi-relational data.

16. The computer readable storage medium of claim 15, the unfolding is performed using hierarchical nonparametric Bayesian collective matrix factorization.

17. The computer readable storage medium of claim 15, wherein the at least two relational matrices comprise commonly shared object types having the same latent membership across the at least two relational matrices.

18. The computer readable storage medium of claim 15, the unfolding further comprising:
using matrix factorization on the at least two relational matrices; and
performing predictive modeling of each relation of the at least two relational matrices.

19. The computer readable storage medium of claim 15, the obtaining co-clustering further comprising:
performing cluster analysis and imputing missing values for an entire row or column vector of the at least two relational matrices.

20. The computer readable storage medium of claim 15, further comprising:
performing interference with Gibbs sampling for the at least two relational matrices.
